(19) United States
(12) Patent Application Publication
(10) Pub. No.: US 2023/0233963 A1
(43) Pub. Date: Jul. 27, 2023

(54) FUEL FILTER

(71) Applicant: ZHEJIANG LAIEN FILTRATION SYSTEM CO., LTD., Huzzzhou City (CN)

(72) Inventors: Jianbin Cheng, Huzhou City (CN); Yu Zhang, Huzhou City (CN); Xiaowei Ying, Huzhou City (CN); Qinglin Deng, Huzhou City (CN)

(73) Assignee: ZHEJIANG LAIEN FILTRATION SYSTEM CO., LTD., Huzhou City, Zhejiang Province (CN)

(21) Appl. No.: 17/962,929

(22) Filed: Oct. 10, 2022

(30) Foreign Application Priority Data
Jan. 25, 2022 (CN) 202220198945.9

(51) Int. Cl. B01D 29/96; B01D 29/11; B01D 35/30

(52) U.S. Cl. CPC B01D 29/96; B01D 29/11; B01D 35/30; B01D 2201/347; B01D 2201/4076; B01D 2201/4092

(57) ABSTRACT

The present application relates to the technical field of filter assemblies, in particular to an improved filter, including a. filter housing connected to a filter assembly, a connector, an end face seal component, and a filter element. “L”-shaped clamping grooves are formed in an inner wall of the connector. Each of the clamping grooves is provided with a limit bulge. A baffle is installed in the connector. At least two or more clamping blocks matched with the clamping grooves are arranged around an outer wall of the baffle. By arranging the baffle, the replacement and installation of the filter element are facilitated.

### CROSS REFERENCE TO RELATED APPLICATION

This application claims priority to Chinese Patent Application No. 202220198945.9, filed on Jan. 5, 2022, which is incorporated herein by reference in its entirety.

### FIELD OF TECHNOLOGY

The present application relates to the technical field of filter assemblies, in particular to an improved filter.

### BACKGROUND

In general, a filter is widely used in the field of fuel filtration of internal combustion engines to filter out debris in fuel, and plays a very important role in filtration. As is well known, a fuel filtration system separates various particles and condensates by means of fuel filtration.

In motor vehicles, various fuel filters are often required to ensure the fuel intake quality of engines. Filter elements of existing filters usually need to be replaced regularly.

In the prior art, a filter element is usually fixed by means of a complex structure in a conventional filter, which makes it tune-consuming and laborious for replacing the filter element; moreover, a threaded connector and a baffle of the conventional filter are integrated, such that the filter element cannot be separately replaced and needs to be replaced as a whole, and high maintenance cost and material waste are resulted; in the conventional filter, it is usually needed that the filter element is installed on the filter first and then an upper cylinder portion and a lower cylinder portion of the filter are welded; for example, the upper cylinder portion and the lower cylinder portion of the filter are welded during use of a friction welding process and during friction welding; for example, fuel leakage is resulted from an unsealed housing caused by insufficiently firm welding of the filter under the condition that the filter element that needs to be installed is relatively high during use of the friction welding process, and the filter element is damaged as a torsional force generated by the upper cylinder portion and the lower cylinder portion during friction welding will act on the filter element; when the filter element that needs to be installed is relatively low, a movement will be produced inside the filter, and the stability is relatively poor, so the axial height needs to be strictly controlled during filter element processing in the conventional filter; and when the conventional filter is scrapped by welding, the filter element inside will also be scrapped, causing material waste and higher production costs.

### SUMMARY

In order to overcome the technical problem existing in the prior art, the present application provides an improved filter. Through the arrangement of a baffle, a filter element may be fixed. Through the arrangement of clamping blocks and clamping grooves, the clamping blocks are correspondingly put into the clamping grooves, then the baffle is rotated clockwise, and the clamping blocks may be clamped by the clamping grooves, such that the baffle is fixed stably, and the baffle firmly fixes the filter element. When the fixed filter element is taken out, the baffle is rotated counterclockwise, the baffle is taken down, and the filter element is taken out and replaced, thereby facilitating the replacement and installation of the filter element.

To achieve the above objective, the present application adopts the following technical solution:

An improved filter, including a filter housing, a connector, an end face seal component, and a filter element configured to be connected to a filter assembly, where “L”-shaped clamping grooves are formed in an inner wall of the connector, each of the clamping grooves is provided with a limit bulge, a baffle is installed in the connector, and at least two or more clamping blocks matched with the clamping grooves are arranged around an outer wall of the baffle. Through the arrangement of the baffle, the filter element may be fixed. Through the arrangement of the clamping blocks and the clamping grooves, the clamping blocks are correspondingly put into the clamping grooves, then the baffle is rotated clockwise, and the clamping blocks may be clamped by the clamping grooves, such that the baffle is fixed stably, and the baffle firmly fixes the filter element. When the fixed filter element is taken out, the baffle is rotated counterclockwise, the baffle is taken down, and the filter element is taken out and replaced, thereby facilitating the replacement and installation of the filter element.

Further, the limit bulge is arranged at an inlet end of a corresponding one of the clamping grooves. The limit bulge is configured to prevent the corresponding clamping block from falling off, such that the baffle is fixed stably.

Further, the limit bulge is provided with a guide face. The limit bulge is provided with the guide face, such that the corresponding clamping block is easily guided into the corresponding clamping groove.

Further, the baffle is provided with a discharge tube and at least two or more connecting blocks. The connecting blocks are configured to connect the discharge tube.

Further, an outlet is formed in the middle of the discharge tube, the filter element is arranged in the filter, and a boss is arranged at a top end of the filter element. The boss is configured to fix the filter element.

Further, the boss is matched with the discharge tube. The filter element and the discharge tube are tightly connected.

Further, an external thread is formed in an outer wall of the connector. The connector is configured to be connected to the filter assembly.

Further, seal grooves are formed in a contact end face of the outlet and a contact end face of the connector, and each of the seal grooves is matched with the end face seal component, such that the seal performance is improved.

Compared with the prior art, the present application has the following beneficial effects:

Through the arrangement of the baffle, the filter element may be fixed. Through the arrangement of the clamping blocks and the clamping grooves, the clamping blocks are correspondingly put into the clamping grooves, then the baffle is rotated clockwise, and the clamping blocks may be clamped by the clamping grooves, such that the baffle is fixed stably, and the baffle firmly fixes the filter element. When the fixed filter element is taken out, the baffle is rotated counterclockwise, the baffle is taken down, and the filter element is taken out and replaced and does not need to be replaced as a whole, thereby facilitating the replacement and installation of the filter element, reducing material waste, and greatly reducing maintenance costs of this filter.

The connector and the baffle are desired to be detachable, such that the filter housing and the connector can be welded first and then the filter element is installed, thereby avoiding the damage to the filter element during welding.

When the filter element that needs to be installed is relatively high, the filter element is installed first and then the filter housing and the connector are welded, such that welding of the filter is relatively firm. When the filter element that needs to be installed is relatively low, the filter housing and the connector are welded first and then the filter element is installed, such that a movement will not produced inside the filter, and the stability is better, so it can be suitable for installing filter elements of different specifications.

According to this filter, the filter housing and the connector can be welded first and then the filter element is installed. When the filter is scrapped by welding, only the filter housing needs to be scrapped, and the filter element will not be scrapped, thereby avoiding material waste and reducing production costs.

### BRIEF DESCRIPTION OF THE DRAWINGS

FIG. 1 is a schematic diagram of a cross-sectional structure of the present application;

FIG. 2 is an enlarged schematic diagram of a clamping groove in the present application;

FIG. 3 is an enlarged schematic diagram of a limit bulge in the present application;

FIG. 4 is a schematic diagram of an overall structure of the present application;

FIG. 5 is a schematic diagram of a cross-sectional structure of a connector in the present application;

FIG. 6 is a schematic bottom view of a nut plate in the present application;

FIG. 7 is a schematic diagram of a front view structure of the nut plate in the present application;

FIG. 8 is a schematic diagram of a top view structure of the nut plate in the present application; and

FIG. 9 is a schematic structural diagram of a seal cover in the present application.

In the figures: 1: filter housing; 2: connector; 3: clamping groove; 31: limit bulge; 311: guide face; 4: baffle; 5: discharge tube; 6: clamping block; 7: inlet; 8: outlet; 9: filter element; 10: boss; 11: end face seal component; and 12: connecting block.

### DETAILED DESCRIPTION

The embodiments of the present application are described in detail below, and the examples of the embodiments are shown in the accompanying drawings. The embodiments described below with reference to the accompanying drawings are exemplary and intended to explain the present application, and should not be construed as a limitation to the present application.

In the description of the present application, it should be understood that the orientational or positional relationships indicated by the terms “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, etc. are based on the orientational or positional relationships shown in the accompanying drawings, are only used for the convenience of describing the present application and simplifying the description rather than indicating or implying that the referred device or element must have a specific orientation or be constructed and operated in a specific orientation, and therefore should not be construed as a limitation to the present application.

In addition, the terms “first” and “second” are only used for descriptive purposes, and should not be construed as indicating or implying relative importance or implying the number of indicated technical features. Thus, the features limited with “first” and “second” may explicitly or implicitly include at least one of the features. In the description of the present application, “a plurality of” means at least two, such as two, three, etc., unless otherwise expressly and specifically limited.

In the present application, the terms “installed”, “connected”, “connection”, “fixed”, etc. should be understood in a broad sense, unless otherwise expressly specified and limited. For example, it may be a fixed connection, a detachable connection, or integrated; it may be a mechanical connection, an electrical connection, or a mutual communication; and it may be directly connected, indirectly connected via an intermediate medium, an internal connection between two elements, or an interactive relationship between the two elements, unless otherwise expressly limited. Those of ordinary skill in the art may understand specific meanings of the above terms in the present application according to specific circumstances.

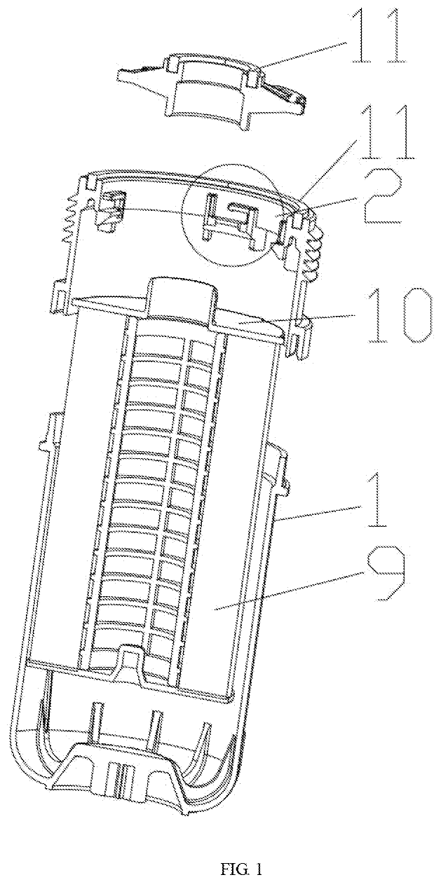

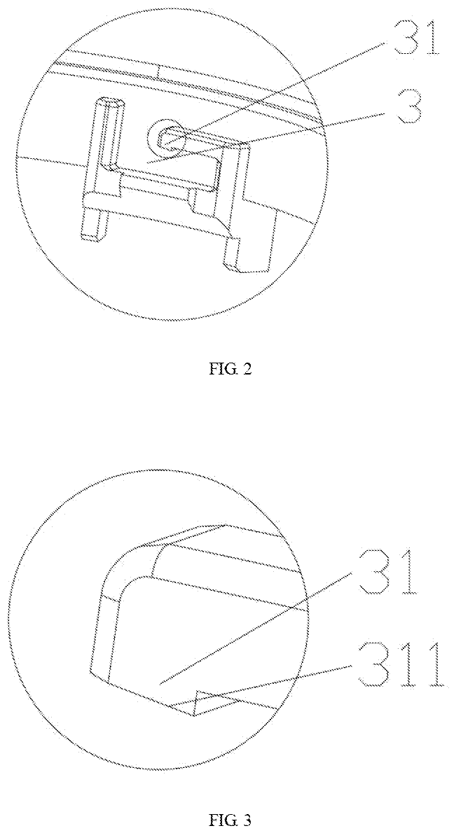

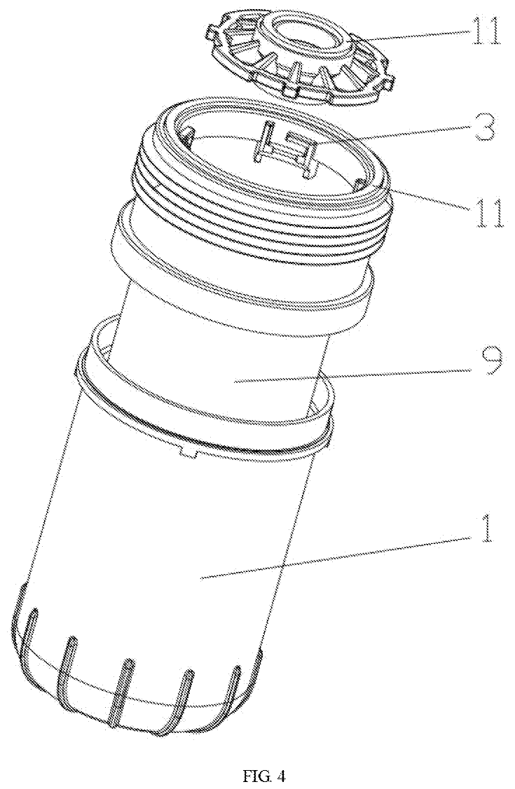

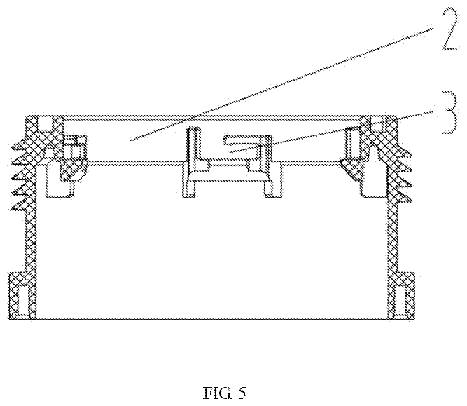

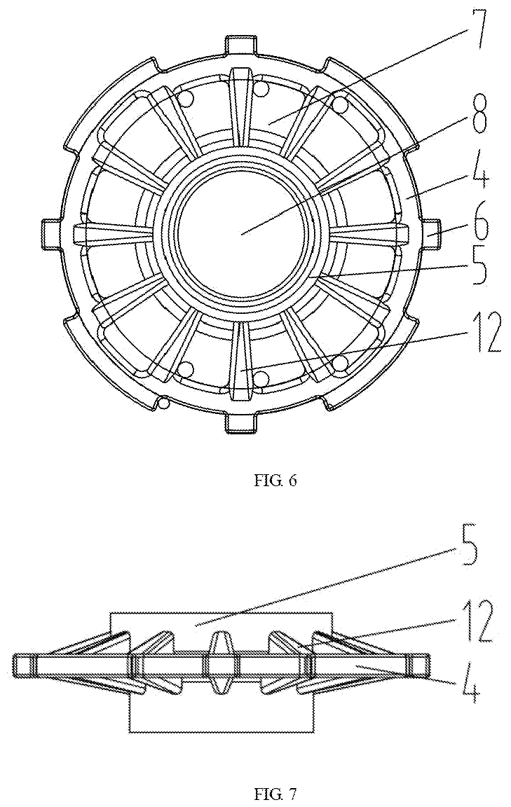

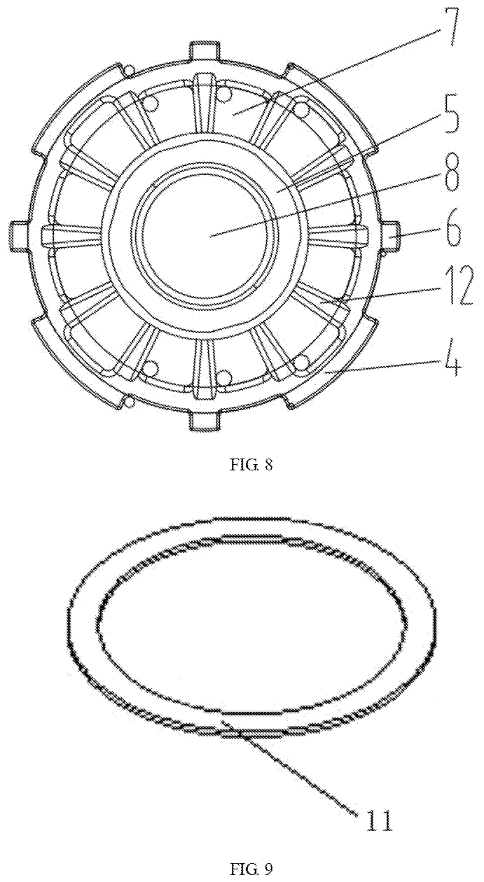

Referring to FIGS. 1 to 9 that show an embodiment of an improved filter in the present application, in this embodiment, the improved filter includes a filter housing 1. A top end of the filter housing 1 is provided with a connector 2. The housing 1 is connected to the connector 2 by means of welding. An outer wall of the connector 2 is formed with an external thread, and the connector is configured to be connected to a filter assembly. An inner wall of the connector 2 is formed with clamping grooves 3, and the clamping grooves 3 are in an “L” shape. A baffle 4 is installed in the connector 2 to fix a filter element 9. A discharge tube 5 is arranged in the middle of the baffle 4. The discharge tube 5 is connected to a boss 10 of the filter element. A filtered fluid is discharged from an outlet 8. At least two or more connecting blocks 14 are arranged between the baffle 4 and the discharge tube 5 to connect the discharge tube 5, and a fluid inlet 7 is formed. At least two or more clamping blocks 6 matched with the clamping grooves 3 are arranged around an outer wall of the baffle 4. Through the arrangement of the clamping blocks 6 and the clamping grooves 3, the clamping blocks 6 are correspondingly put into the clamping grooves 3. By rotating the baffle 4, the clamping blocks 6 may be clamped by the clamping grooves 3. A limit bulge 31 is arranged at the top of each of the clamping grooves 3 to prevent the corresponding clamping block 6 from filling off, such that the baffle 4 is fixed stably, and the baffle 4 firmly fixes the filter element 9. The limit bulge 31 is provided with a guide face 311, such that the corresponding clamping block. 6 is easily guided into the corresponding clamping groove 3. The guide face is generally set to be an inclined face. When the fixed filter element needs to be taken out, the baffle 4 is driven to rotate in reverse, the baffle 4 is taken down, and the filter element 9 is taken out and replaced, thereby facilitating the replacement and installation of the filter element 9, effectively improving the replacement efficiency of the filter element 9, avoiding the replacement of the overall filter, and reducing the maintenance cost.

The inlet 7 is formed between the at least two or more connecting blocks 12. An unfiltered fluid enters the filter housing 1 from the inlet 7. The outlet 8 is formed in the middle of the discharge tube 5. A filtered clean fluid flows out from the outlet 8. An end face seal component 11 is installed in the outlet 8 to separate the unfiltered fluid from the clean fluid during filtration. The filter element 9 is arranged in the filter to filter the fluid. The boss 10 is arranged at a top end of the filter element 9, and an outer wall of the boss 10 is matched with an inner wall of the discharge tube 5 to fix the filter element 9 and enable the filter element 9 and the discharge tube 5 to be tightly connected.

In conclusion, during use of the improved filter, the filter is connected to other devices to filter the fluid. During replacement of the filter element 9, the baffle 4 is rotated in reverse, the baffle 4 is taken down, the filter element 9 is taken out, the filter element 9 is replaced, a new filter element 9 is installed in the filter housing 1, the discharge tube 5 is sleeved outside the boss 10, and the clamping blocks 6 are rotated and clamped into the clamping grooves 3, such that the replacement of the filter element 9 may be completed.

The above embodiments only express several implementations of the present application and are described more specifically and in details, but they should not be construed as a limitation to the scope of the patent of the application. It should be pointed out that those of ordinary skill in the art may also make several modifications and improvements without departing from the conception of the present application, and these modifications and improvements fall within the scope of protection of the present application. Therefore, the scope of protection of the patent of the present application should be determined by the appended claims.

What is claimed is:

1. A filter, comprising a filter housing, a connector, an end face seal component, and a filter element configured to be connected to a filter assembly, wherein “L”-shaped clamping grooves are formed in an inner wall of the connector, each of the clamping grooves is provided with a limit bulge, a baffle is installed in the connector, and at least two or more clamping blocks matched with the clamping grooves are arranged around an outer wall of the baffle.

2. The filter according to claim 1, wherein the limit bulge is arranged at an inlet end of a corresponding one of the clamping grooves.

3. The filter according to claim 1, wherein the limit bulge is provided with a guide face.

4. The filter according to claim 1, wherein the baffle is provided with a discharge tube and at least two or more connecting blocks.

5. The filter according to claim 4, wherein an outlet is formed in the middle of the discharge tube, the filter element is arranged in the filter, and a boss is arranged at a top end of the filter element.

6. The filter according to claim 5, wherein the boss is matched with the discharge tube.

7. The filter according to claim 1, wherein an external thread is formed in an outer wall of the connector.

8. The filter according to claim 5, wherein seal grooves are formed in a contact end face of the outlet and a contact end face of the connector, and each of the seal grooves is matched with an end face seal component.

9. The filter according to claim 6, wherein seal grooves are formed in a contact end face of the outlet and a contact end face of the connector, and each of the seal grooves is matched with an end face seal component.
